(19) United States
(12) Patent Application Publication
(10) Pub. No.: US 2026/0281749 A1
(43) Pub. Date: Sep. 17, 2026

(54) SYSTEM AND A METHOD FOR ENABLING WIFI EXTENDER IN A USER ENVIRONMENT

(71) Applicant: SAMSUNG ELECTRONICS CO., LTD., Suwon-si (KR)

(72) Inventor: Sheetal ARYA, Uttar Pradesh (IN)

(73) Assignee: SAMSUNG ELECTRONICS CO., LTD., Suwon-si (KR)

(21) Appl. No.: 19/678,751

(22) Filed: May 15, 2026

Related U.S. Application Data
(63) Continuation of application No. PCT/KR2024/004759, filed on Apr. 9, 2024.

(30) Foreign Application Priority Data
Nov. 15, 2023 (IN) 202311077597

(51) Int. Cl. H04W 24/02; H04W 16/26; H04W 24/08; H04W 84/12

(52) U.S. Cl. CPC H04W 24/02; H04W 16/26; H04W 24/08; H04W 84/12

(57) ABSTRACT

A method for enabling one or more Wireless-Fidelity (Wi-Fi) extenders in a user environment. The method comprises determining signal quality of one or more areas in the user environment, identifying, boundary coordinates of one or more sub-areas around one or more weak strength devices, detecting one or more strong strength devices located in the proximity of the identified boundary coordinates of the one or more sub-areas, identifying one or more candidate strong strength devices from the detected one or more strong strength devices and enabling the identified one or more candidate strong-strength devices to operate as the one or more Wi-Fi extenders

### CROSS-REFERENCE TO RELATED APPLICATIONS

This application is a continuation of International Application No. PCT/KR2024/004759, filed on Apr. 9, 2024 and also claims priority to Indian Provisional Patent Application No. 202311077597, filed on Nov. 15, 2023. The disclosures of each of which are incorporated by reference herein in their entireties.

### TECHNICAL FIELD

The present disclosure generally relates to the field of Internet of Things (IoT) environment, and more particularly relates to a system and a method for identifying and enabling Wireless-Fidelity (Wi-Fi) extenders in an IoT environment.

### BACKGROUND ART

With the increasing dependency on internet in devices, there is a growing demand for good internet bandwidth across all these devices. For example, devices may include smart device. Further, a distance between the devices and the router plays an important role in providing good signal strength to the devices. However, in scenarios where the distance between the device and a router is significant, the signal strength fades at the device. Thus, the device experiences a weaker Wireless-Fidelity (Wi-Fi) signal due to its distance from the router. For example, a refrigerator in the kitchen may experience a weaker Wi-Fi signal if the router is placed far away from the kitchen.

The consequence of insufficient signal strength is that internet-dependent refrigerator applications may not run smoothly. Accordingly, a Wi-Fi extender can be utilized for enhancing the signal strength. However, presently, an additional device is required to be bought by a user to obtain better coverage and a reliable connection. This adds an additional cost for hardware to the user.

As the current home environment includes various devices, it is crucial to have a strong and stable internet connection throughout the home. By incorporating technologies like Wi-Fi extenders, one can ensure that all devices receive the necessary internet bandwidth, even in areas with weak Wi-Fi signals. This shall further enhance the user experience and allow for the seamless operation of internet-dependent applications across all devices.

Accordingly, there lies a need for an improved technique and method associated with the Wi-Fi extenders.

### DISCLOSURE OF INVENTION

### Solution to Problem

According to an embodiment of the present disclosure, a method for enabling one or more Wireless-Fidelity (Wi-Fi) extenders in a user environment is provided. The method includes determining a signal quality of one or more areas in the user environment based on at least one of one or more device device parameters, one or more device capabilities, or a Wi-Fi signal strength of the one or more devices. The method includes identifying, based on the determined signal quality, the one or more device parameters, and one or more area parameters, boundary coordinates of one or more sub-areas around one or more weak strength devices, from among the one or more devices, having a first Wi-Fi signal strength that is less than a predefined threshold signal strength. The method includes detecting, based on the one or more device parameters, the one or more area parameters, and the Wi-Fi signal strength of the one or more devices, one or more strong strength devices located in proximity of the identified boundary coordinates of the one or more sub-areas, the detected one or more strong strength devices having a second Wi-Fi signal strength that is more than the predefined threshold signal strength. The method includes identifying one or more candidate strong strength devices from the detected one or more strong strength devices based on one or more extender parameters. The method includes enabling the identified one or more candidate strong strength devices to operate as the one or more Wi-Fi extenders for the one or more weak strength devices located in the user environment.

According to an embodiment of the present disclosure, a system for enabling one or more Wireless-Fidelity (Wi-Fi) extenders in a user environment is disclosed. The system comprises a memory to store one or more computer programs and one or more processors communicatively coupled to the memory. The one or more processors execute the one or more computer programs or at least one instruction stored in the memory to cause the system to determine a signal quality of one or more areas in the user environment based on one or more device parameters, one or more device capabilities, and a Wi-Fi signal strength of one or more devices.

The one or more processors execute the one or more computer programs or at least one instruction stored in the memory to cause the system to identify, based on the determined signal quality, the one or more device parameters, and one or more area parameters, boundary coordinates of one or more sub-areas around one or more weak strength devices, from among the one or more devices having a first Wi-Fi signal strength that is less than a predefined threshold signal strength. The one or more processors execute the one or more computer programs or at least one instruction stored in the memory to cause the system to detect, based on the one or more device parameters, the one or more area parameters, and the Wi-Fi signal strength of the one or more devices, one or more strong strength devices located in the proximity of the identified boundary coordinates of the one or more sub-areas, the detected one or more strong strength devices having a second Wi-Fi signal strength that is more than the predefined threshold signal strength and identify one or more candidate strong strength devices from the detected one or more strong strength devices based on one or more extender parameters. The one or more processors execute the one or more computer programs or at least one instruction stored in the memory to cause the system to enable the identified one or more candidate strong-strength devices to operate as the one or more Wi-Fi extenders for the one or more weak-strength devices located in the user environment.

According to an embodiment of the present disclosure, a computer readable medium storing therein instructions executable to cause at least one processor of a system to implement the method is disclosed. The method includes determining a signal quality of each of one or more areas in the user environment based on at least one of one or more device parameters, one or more device capabilities, or a Wi-Fi signal strength of the one or more devices, respectively. The method includes identifying, based on the determined signal quality, the one or more device parameters, and one or more area parameters, boundary coordinates of one or more sub-areas around one or more weak strength devices, from among the one or more devices, having a first Wi-Fi signal strength that is less than a predefined threshold signal strength. The method includes detecting, based on the one or more device parameters, the one or more area parameters, and the Wi-Fi signal strength of the one or more devices, one or more strong strength devices located in the proximity of the identified boundary coordinates of the one or more sub-areas, the detected one or more strong strength devices having a second Wi-Fi signal strength that is more than the predefined threshold signal strength. The method includes identifying one or more candidate strong strength devices from the detected one or more strong strength devices based on one or more extender parameters. The method includes enabling the identified one or more candidate strong strength devices to operate as the one or more Wi-Fi extenders for the one or more weak strength devices located in the user environment.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates an overview of an operation flow for identifying and enabling the best available Wi-Fi extender, according to an embodiment of the present disclosure;

FIG. 2 illustrates an exemplary general architecture of a system according to an embodiment of the present disclosure;

FIG. 3 illustrates a high-level architecture of the system of the system, according to an embodiment of the present disclosure;

FIG. 4 illustrates an operation flow 400 for enabling one or more Wi-Fi extenders, according to an embodiment of the present disclosure;

FIG. 5 illustrates a flow chart of method for enabling one or more Wi-Fi extenders, according to an embodiment of the present disclosure;

FIG. 6 illustrates an example of the blueprint of the home environment, according to an embodiment of the present disclosure;

FIG. 7 illustrates an example low reception area demarcation, according to an embodiment of the present disclosure;

FIG. 8 illustrates an example of the shape of the room and wall, according to an embodiment of the present disclosure;

FIG. 9 illustrates an example scenario of shortlisting the one or more strong-strength devices, according to an embodiment of the present disclosure; and

FIG. 10 illustrates an example scenario for device multiplexing, according to an embodiment of the present disclosure.

Further, skilled artisans will appreciate that those elements in the drawings are illustrated for simplicity and may not have necessarily been drawn to scale. For example, the flow charts illustrate the method in terms of the most prominent operations involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### MODE FOR THE INVENTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP), a communication processor (CP), a graphical processing unit (GPU), a neural processing unit (NPU), a microprocessor unit (MPU), a system on chip (SoC), an IC, or the like. Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps (operations) does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

According to an embodiment, the present disclosure discloses a method and a system for enabling one or more Wireless-Fidelity (Wi-Fi) extenders in a user environment. In an embodiment, the user environment may refer to the entire area where one or more devices present and utilize Wi-Fi. In a non-limiting example, the user environment may include a home environment, an office environment, or an environment where one or more devices present and utilize Wi-Fi. According to an embodiment, the disclosed methodology identifies the best available Wi-Fi extender in the user environment.

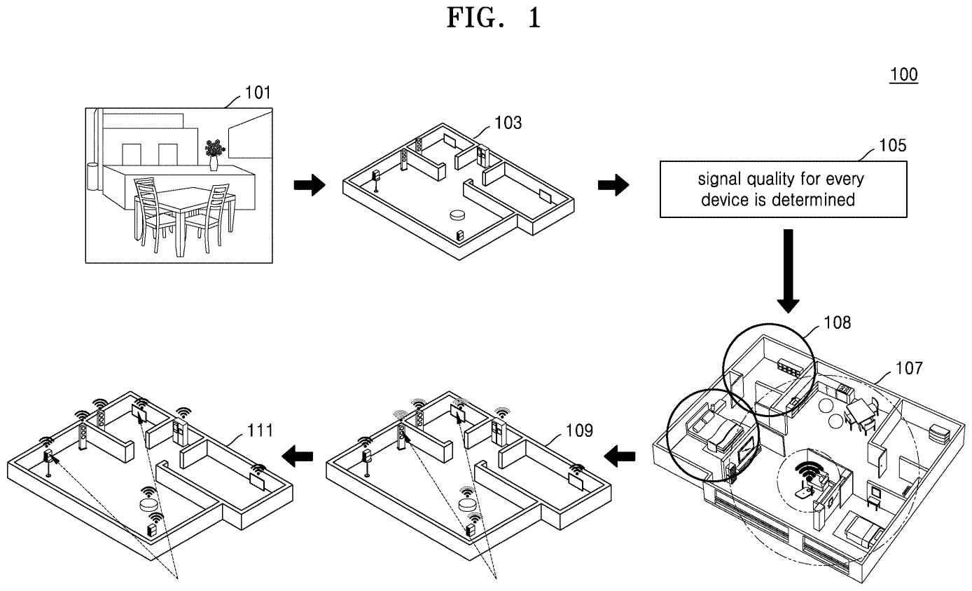

FIG. 1 illustrates an overview of an operation flow 100 for identifying and enabling the best available Wi-Fi extender, according to an embodiment of the present disclosure. In an embodiment, at operation 101, one or more area parameters are determined by using image-capturing devices. In a non-limiting example, the image-capturing devices includes devices having inbuilt cameras, web cameras, camera installed in the user environment and the like. In a non-limiting example, the one or more area parameters include at least one of a number of the one or more areas in the user environment, area coordinates, shape of the area, wall coordinates, wall shape, wall width, wall thickness of each of the one or more areas, or information associated with the one or more devices present in each of the one or more areas. In an embodiment, at operation 103, one or more device parameters are determined. In an example, the one or more devices herein are referred to as one or more devices present in respective areas in the user environment. For example, the one or more devices may include smart device. In an embodiment, the device parameters include at least one of an identifier associated with the one or more devices, location coordinates of the one or more devices, or a type of the one or more devices. In an embodiment, at operation 105, a signal quality for every device is determined through the one or more device parameters and device capabilities. In an embodiment, at operation 107, boundary coordinates 108 of one or more sub-areas around one or more weak strength devices are identified based on the signal quality, the one or more device parameters, and the one or more area parameters.

In an embodiment, at operation 109, one or more strong strength devices are detected that are in proximity of the identified boundary coordinates of the one or more sub-areas. In an embodiment, at operation 111, one or more strong strength devices are identified from the detected one or more strong strength devices. In an embodiment, the one or more strong strength devices are enabled as one or more Wi-Fi extenders for the one or more weak-strength devices located in the user environment.

A detailed methodology is explained in the following paragraphs of the disclosure.

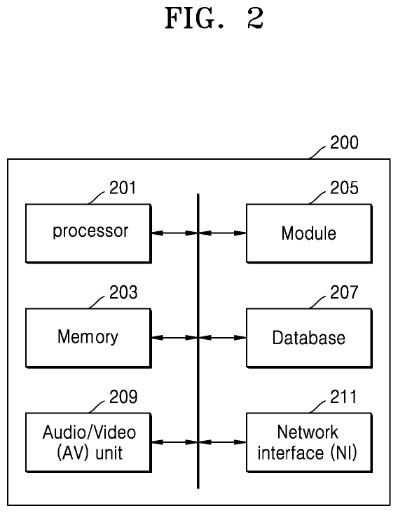

FIG. 2 illustrates an exemplary general architecture of a system 200 according to an embodiment of the present disclosure. The system 200 is configured to implement a method for enabling Wi-Fi extenders in the user environment. The system 200 includes a processor(s) 201, a memory 203, a module(s) 205, a database 207, and a network interface (NI) 211 coupled with each other.

As an example, the system 200 may be implemented in various devices such as a Personal Computer (PC), tablet, smartphone, a desktop computer, electronic devices, a cloud server, a remote server, smart refrigerator, and the like. As an example, the system 200 may be operatively communicates with one or more devices. In an embodiment, the device may be an smart device. As an example, the smart devices include a smart AC (Air Conditioner), a smart refrigerator, a smart camera, smart washing machine and the like.

In an example, the processor 201 may be a single processing unit or a number of units, all of which could include multiple computing units. The processor 201 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 201 is configured to fetch and execute computer-readable instructions and data stored in the memory 203.

The memory 203 may include computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

As an example, the module(s) 205 may include a program, a subroutine, a portion of a program, a software component, or a hardware component capable of performing a stated task or function. As used herein, the module(s) 205 may be implemented on a hardware component such as a server independently of other modules, or a module can exist with other modules on the same server, or within the same program. The module(s) 205 may be implemented on a hardware component such as processor one or more microprocessors, microcomputers, microcontrollers, digital signal processors, central processing units, state machines, logic circuitries, and/or any devices that manipulate signals based on operational instructions. The module(s) 205 when executed by the processor(s) 201 may be configured to perform any of the described functionalities here in the disclosure.

In an embodiment, the database 207 may be implemented with integrated hardware and software. The hardware may include a hardware disk controller with programmable search capabilities or a software system running on general-purpose hardware. The examples of the database 207 includes, but are not limited to, in-memory databases, cloud databases, distributed databases, embedded databases, and the like. The database 207, amongst other things, serves as a repository for storing data processed, received, and generated by one or more of the processors, and the modules/engines/units.

In an embodiment, the module(s) 205 may be implemented using one or more AI modules that may include a plurality of neural network layers. Examples of neural networks include but are not limited to, Convolutional Neural Network (CNN), Deep Neural Network (DNN), Recurrent Neural Network (RNN), Restricted Boltzmann Machine (RBM). Further, ‘learning’ may be referred to in the disclosure as a method for training a predetermined target device (for example, a robot) using a plurality of learning data to cause, allow, or control the target device to make a determination or prediction. Examples of learning techniques include but are not limited to supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with an AI module may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). One or a plurality of processors control the processing of the input data in accordance with a predefined operating rule or artificial intelligence (AI) model stored in the non-volatile memory and the volatile memory. The predefined operating rule or artificial intelligence model is provided through training or learning.

As an example, the NI unit 209 establishes a network connection with a network like a home network, a public network, a private network, a cloud network, and the like.

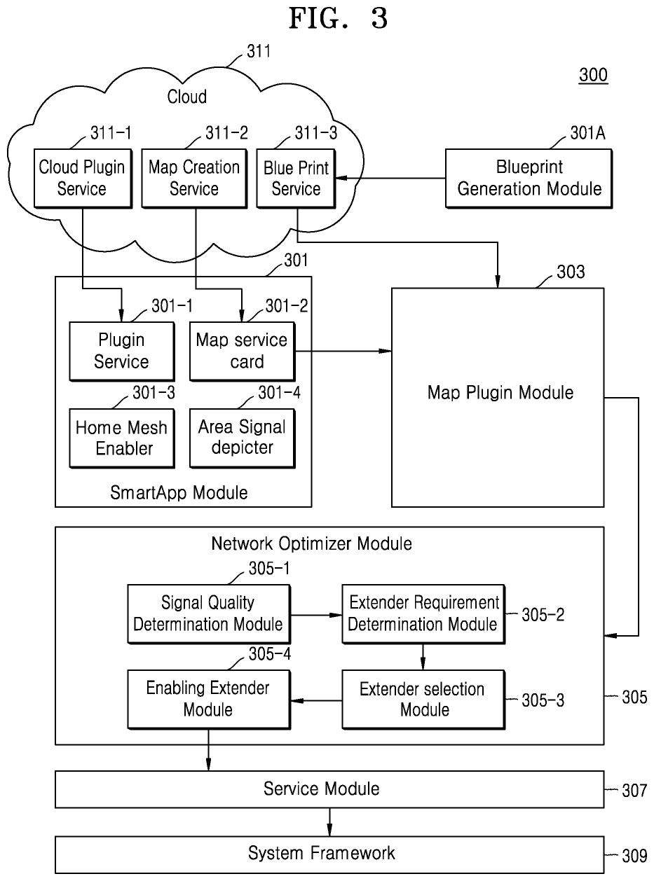

FIG. 3 illustrates a high-level architecture of the system of FIG. 2, according to an embodiment of the present disclosure. In an embodiment, the system 300 includes various modules such as an SmartApp module 301, a map plugin module 303, a network optimizer module 305, an service module 307, and a system framework 309. In an embodiment, the aforesaid modules may be implemented in the module 205 of FIG. 2. In an embodiment, the system 200, 300 may control the various modules to perform operations, or the one or more processors 201 execute the program or at least one instruction stored in the memory 203 to cause the system 200, 300 perform the operations. In the following embodiments, the system 300 control the various modules so that the various modules perform operations. In an embodiment, the SmartApp 301 is in communication with a cloud 311 for obtaining various information. In a non-limiting example, the cloud 311 includes Cloud Plugin service 311-1, Map Creation Service 311-2, Blue Print service 311-3, and the like. In an embodiment, the Cloud Plugin service 311-1 provides information related to plugin services implemented in the system 300. In an embodiment, the Map Creation Service 311-2 provides information related to map service card implemented in the system 300 to the map plugin module 303. In an embodiment, the Blue Print service 311-3 renders information related to floor maps by using the blueprint generation module 301A. The Blue Print service 311-3 provides the blueprint to the map plugin module 303. As an example, the blueprint includes details related to a floor map, positions of the one or more devices, a shape of the user environment, wall coordinates, and the like.

In an embodiment, the SmartApp module 301 determines details of the one or more areas in the user environment, details related to the devices, and text information associated with the one or more areas and the devices. In an embodiment, the SmartApp module 301 includes plugin service 301-1 to provide information related to plugin services, map service card 301-2 to provide information related to map service cards, home mesh enabler 301-3 for providing options for the user to enable network optimization in home and enabling network optimization process in the system 200. In an embodiment, the SmartApp module 301 includes area signal depicter 301-4 for determining a current status of the signal quality in a specific area presented in the blueprint.

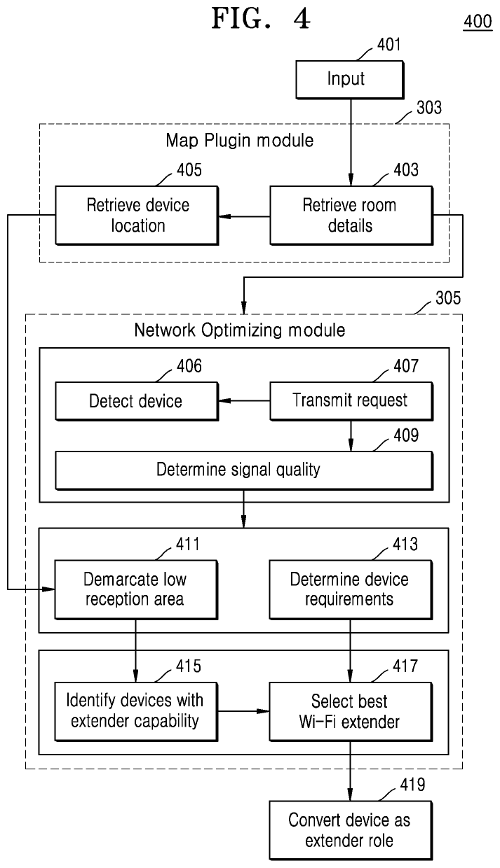

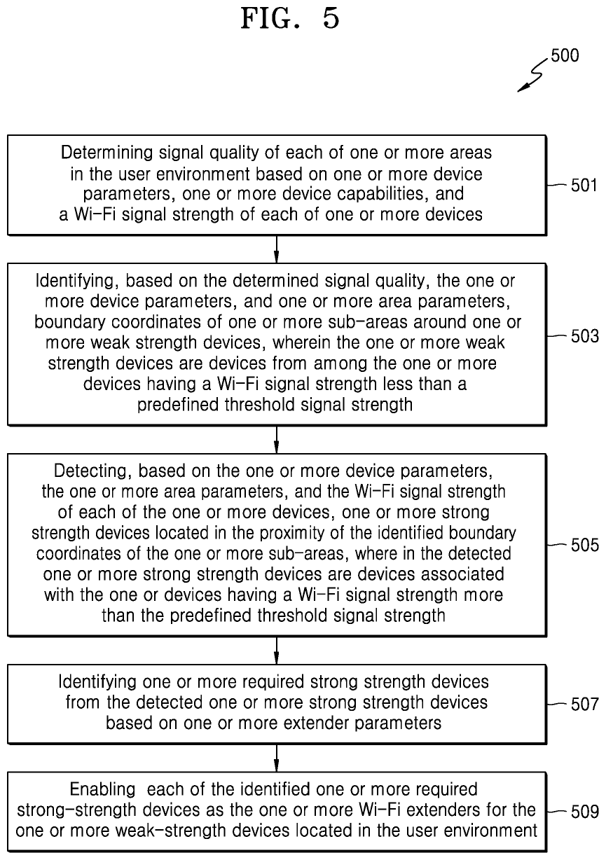

In an embodiment, the map plugin module 303 of the system 300 includes plugin platform Application Interface (APIs) to maintain the location details of one or more areas and devices which are fetched from the floor map in Blue Print service 311-3 in the cloud 311. According to an embodiment, the network optimizer module 305 includes a signal quality determination module 305-1, an extender requirement determination module 305-2, an extender selection module 305-3, and an enabling extender module 305-4. The enabling extender module 305-4 may be alternately referred to as enabling module throughout the disclosure. A detailed working and operation of each of the modules in the network optimizer module 305 will be explained along with FIGS. 4 and 5 collectively for the sake of brevity. In an embodiment, the network optimizer module 305 further coupled and communicates with the service module 307 and system framework 309 for enabling the identified one or more required strong-strength devices as the one or more Wi-Fi extenders. The forthcoming paragraphs explain the detailed working of the system 300 by referring to the FIGS. 2 and 3.

FIG. 4 illustrates an operation flow 400 for enabling one or more Wi-Fi extenders, according to an embodiment of the present disclosure. In an embodiment, FIG. 5 illustrates a flow chart of method 500 for enabling one or more Wi-Fi extenders, according to an embodiment of the present disclosure. In an embodiment, the operation flow 400 depicts the sequence of operations performed by the system 300. The operation flow 400 will be explained collectively with the method 500 through FIGS. 2 to 10 for the ease of understanding and sake of brevity. In an embodiment, the explanation will be made by considering a home environment as the user environment. Hence should not be consider as limiting. Initially, at operation 401, the blueprint generation module 301A receives live data associated with the user environment from one or more image-capturing devices. In an embodiment, the blueprint generation module 301A generates the blueprint associated with the user environment based on the received live data. As explained above, the blueprint comprises details related to the floor map, the positions of the one or more devices, the shape of the user environment, the wall coordinates, and the like. In an embodiment, the blueprint is generated by utilizing the information provided by the Blue Print service 311-3 of FIG. 3.

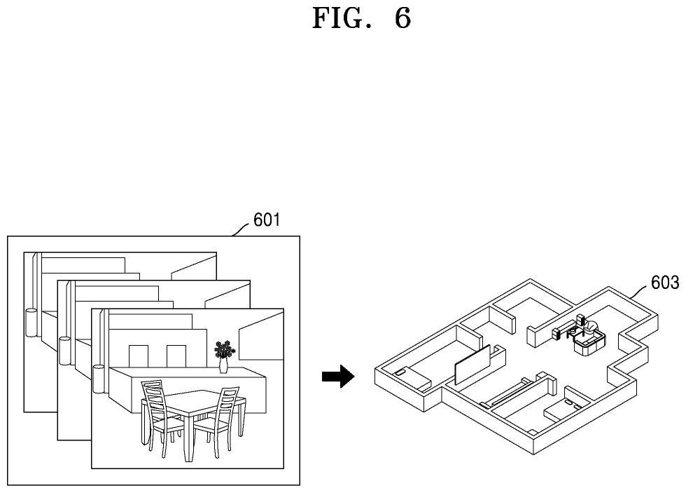

FIG. 6 illustrates an example of the blueprint of the home environment, according to an embodiment of the present disclosure. In an embodiment, the blueprint generation module 301A receives a live data associated with the user environment. In an embodiment, the live data includes at least one live image 601 of a home layout from the image-capturing devices. For example, the at least one live image 601 includes one or more images of the user environment. In an embodiment, a movable camera in a robot vacuum cleaner, or any movable device having an inbuilt camera can capture the live data of the home environment. In an embodiment, a streaming App's may be used to capture the live image. In an embodiment, the blueprint generation module 301A generate a blueprint 603 of the floor map based on the received live image 601. In an embodiment, the blueprint 603 comprises details related to a floor map, positions of the one or more devices, a shape of the user environment, and wall coordinates.

Referring back to FIG. 4, the map plugin module 303, at operation 403 retrieves the room details by using the blueprint. In an embodiment, room details include at least one of the room ID, geometry of the room. In an embodiment, the geometry of the room includes at least one of a type, coordinates of a plane or coordinates of a wall. For example, the ID of the room is “room_00001”, the type of the room is “square”, the coordinates of the plane of the room are “(162, 96), (184, 96), (184, 108), (162, 108)” for four corners, and the coordinate of the is “(162, 80)” for left-top corner. In an embodiment, the map plugin module 303 determines the one or more area parameters associated with each of one or more areas in the user environment by using at least one of the room details or the blueprint. In an embodiment, an area or the one or more area may be alternately referred to room or rooms respectively.

In an embodiment, the map plugin module 303 fetches a room's coordinates, the shape, the wall width information, and the device positioned in the room from the blueprint at operation 403. In an embodiment, based on the shape, a definite structure of the room can be determined. For example, for a square shape, it is determined that the room has four coordinates. In an embodiment, based on the blueprint, respective rooms are identified with their respective room identification (ID) or room name. In an embodiment, the wall is designated with identifiers, the coordinates, the width, and the height are determined as the wall width information.

In an embodiment, the map plugin module 303, at operation 405, retrieves the device location. That is to say, the map plugin module 303, identifies, for every identified room, the positions of the one or more devices that are available. Accordingly, the map plugin module 303 identifies the one or more device parameters associated with each of the one or more devices located in each of the one or more areas based on the determined one or more area parameters and the blueprint.

According to an embodiment, the signal quality determination module 305-1, of the network optimizer module 305, determines the signal quality of each of one or more areas based on the one or more device parameters (as obtained above), the one or more device capabilities, and a Wi-Fi signal strength of each of one or more devices available in the one or more area. In an embodiment, for determining the signal quality of each of one or more areas, the devices with Wi-Fi capability must be discovered and listed. In an embodiment, the one or more device capabilities correspond to the Wi-Fi capability of the one or more devices in the user environment. As an example, the Wi-Fi capability relates to at least one of a capability of the devices acting as the Wi-Fi extender, a capability of projecting signal, and the like. According to an embodiment, at operation 406, the signal quality determination module 305-1 detects a device by using the BLE (Bluetooth low energy) discovery technique. For doing so, the signal quality determination module 305-1 transmits a request to each of the one or more devices for obtaining the one or more device capabilities associated with each of the one or more devices. Based on the transmitted request, the signal quality determination module 305-1 obtains the one or more device capabilities from each of the one or more device. In an embodiment, upon obtaining the one or more device capabilities, operation 407, the signal quality determination module 305-1 transmits a request to each of the one or more devices for obtaining the Wi-Fi signal strength associated with each of the one or more devices at. In an embodiment, the signal quality determination module 305-1 obtains the Wi-Fi signal strength from each of the one or more devices based on the transmitted request. As an example, the devices share the signal strength, a received signal strength indicator (RSSI) value in dBm. In an embodiment, at operation 409, the signal quality determination module 305-1 determines the signal quality of each of the one or more areas based on the one or more device parameters, the obtained one or more device capabilities, and the obtained Wi-Fi signal strength of each of the one or more devices. Accordingly, the one or more area is marked with poor signal quality or good signal quality. In an embodiment, the devices that are present in poor signal rooms are marked as a poor signal receiving devices (PSRD). While the devices that are present in good signal rooms are marked as good signal receiving devices (GSRD) and are kept out of identified low reception area. In an embodiment, low reception area includes one or more sub-areas where received signal strength on the devices is less than a predefined threshold signal strength.

In an embodiment, the devices that are present in good signal rooms are further considered as candidates for extender role, hence Object of Interest (Ool) in the further operations. In an embodiment, signal quality determination module 305-1 obtains a target room identifier list having the one or more areas with poor signal quality. The target room identifier list, one or more area parameters and the one or more device parameters are then provided to the extender requirement determination module 305-2.

In an embodiment, the operation of the determination of the signal determines signal quality of each of one or more areas in the user environment by the signal quality determination module 305-1 corresponds to the operation 501 of FIG. 5.

In an embodiment, the extender requirement determination module 305-2, at operation 411 demarcates low reception area. According to an embodiment, the extender requirement determination module 305-2 the extender requirement determination module 305-2 identifies boundary coordinates of one or more sub-areas around one or more weak strength devices based on the determined signal quality, the one or more device parameters, and one or more area parameters. The one or more weak strength devices are the devices from among the one or more devices having a Wi-Fi signal strength less than a predefined threshold signal strength. In particular, the extender requirement determination module 305-2 identifies the boundary coordinates of the low reception area around the PSRD.

In an embodiment, for identifying the boundary coordinates of one or more sub-areas around the one or more weak strength devices, the extender requirement determination module 305-2 classifies each of the one or more areas into one of a poor-quality signal area and a good quality signal area based on the determined signal quality of each of the one or more areas. In an embodiment, the extender requirement determination module 305-2 identifies the boundary coordinates of the one or more sub-areas located inside the poor-quality signal area based on the determined signal quality, the one or more device parameters, one or more coordinate factors, and the one or more area parameters.

In particular, the extender requirement determination module 305-2 utilize parameters like device location, room coordinate, the walls coordinate's and to define the boundary coordinates of the low reception area. In an embodiment, low reception area refers to the one or more sub-areas located inside the poor-quality signal area. Once the boundary of the low reception area is known, the nearby devices which are extender capable are nominated as best candidates.

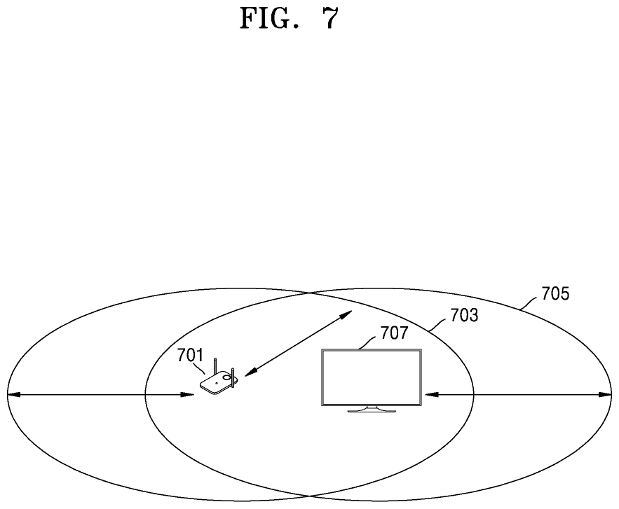

FIG. 7 illustrates an example low reception area demarcation, according to an embodiment of the present disclosure. In an embodiment, a good signal quality area 703 is demarcated. For example, the good signal quality area 703 is where the existing Wi-Fi router 701 provides good signal. In an embodiment, the low reception area 705 is demarcated. For example, the low reception area 705 is where the existing Wi-Fi router 701 cannot provide good signal to the devices falling in the low reception area 705. However, TV 707 can be considered as the extender capable device near to the low reception area. In an embodiment, if the TV 707 is converted as the Wi-Fi extender, the signal coverage will be extended to a distance=Y+Δ, where is a part of low reception area.

In an embodiment, the extender requirement determination module 305-2 calculate and mark boundary (Δ) coordinates of low reception areas 705, so that the GSRD near to these coordinates can be located and marked as Ool. In an embodiment, the low reception area 705 boundaries are decided on the basis of PSRD location, the shape of the room and the wall coordinates.

In an embodiment, with the given device (i.e. PSRD) coordinates by the Map Plugin 303, the expected Wi-Fi signal coverage can be determined. For example, 120 feet (~35 meters) can be considered as the maximum signal coverage and added to PSRD's current position to find maximum coordinates. The equation for the same is given as below.

$$d 1 \cdot x = {psrd}_{01} \cdot pos \cdot x + {wifi}_{bm} ; where {wifi}_{bm} = const\_val \qquad ( 1 )$$

$$Where , d 1 \cdot x = Device maximum X coordinate ( Output ) ,$$

$${psrd}_{01} \cdot pos \cdot x = Poor signal receiving device x coordinate ,$$

$${wifi}_{bm} = Wifi signal strength max ( receiving ) range which is constant value .$$

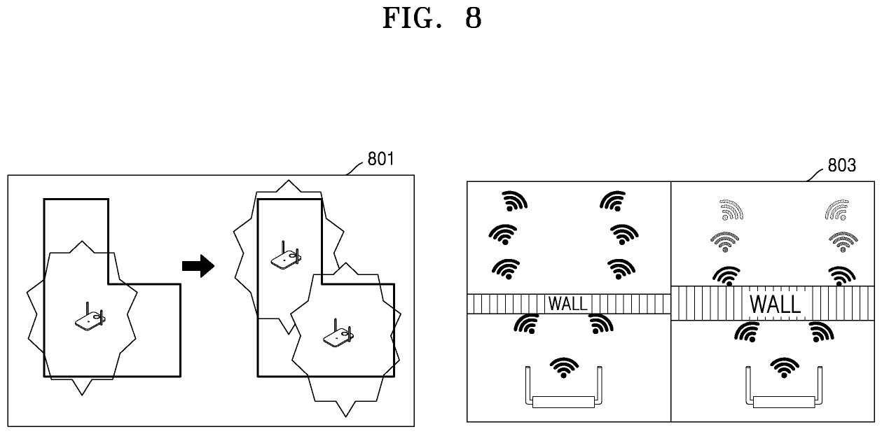

In an embodiment, a relative distance around PSRD is determined found, and marked as its boundary coordinates. In an embodiment, the shape of the room is also considered a vital factor when calculating the boundary coordinates considering maximum signal coverage distance. FIG. 8 illustrates an example of the shape of the room and wall, according to an embodiment of the present disclosure. In an embodiment, FIG. 8, at block 801, if the room is in an “L” shape, then the room's coordinates depend on its curve, and it will be considered as the boundary's coordinates. The shape of the room is calculated based on the equation 2.

$$d 1 \cdot x = ( ( {psrd}_{01} \cdot pos \cdot x + {wifi}_{bm} ) > curve \cdot pos ) ? {psrd}_{01} \cdot pos \cdot x + curve \cdot pos : {psrd}_{01} \cdot pos \cdot x + {wifi}_{bm} \qquad ( 2 )$$

$$Where , d 1 \cdot x = Device maximum X coordinate ( output ) ,$$

$${psrd}_{01} \cdot pos \cdot x = Poor signal receiving device x coordinate$$

$${wifi}_{bm} = Wi - fi signal strength max ( receiving ) range which is constant value ,$$

$$curve \cdot pos = Wall curve position$$

In an embodiment, in block 803, the thickness of the wall plays an important role in the signal propagation. The wall with less thickness can propagate the signals effectively than the wall which is more thicker. In an embodiment, the thickness of the wall also plays a vital role in determining the signal strength of the device. In an embodiment, the captured wall coordinates will be utilized to calculate signal strength coverage. The wall coordinates can be calculated with equation 3 below.

$$d 1 \cdot x = ( {wall}_{0.1} \cdot width \geq {min}_{wid} ) ? {wall}_{01 \cdot x :} {psrd}_{01} \cdot pos \cdot x + {wifi}_{bm} ; \qquad ( 3 )$$

$$where {min}_{wid} = const\_val$$

$$Where , d 1 \cdot x = Device maximum x coordinate ( output ) ,$$

$${wall}_{01} \cdot width = width of wall ,$$

$${min}_{wid} = minimum width is constant value required for Wi - Fi strength allowance ,$$

$${psrd}_{01} \cdot pos \cdot x = poor signal receiving device x coordinate ,$$

$${wifi}_{bm} == Wifi signal strength max ( receiving ) range which is constant value .$$

In an embodiment, the identified low reception area can be single or multiple in a room, therefore identifiers are assigned. In an embodiment, device position are mentioned in the scalar form (x, y). In an embodiment, gradient coordinates are calculated for determining a vectors of the boundaries based on the equation 4.

$${dz}_{01} = \sum {dz}_{a} \cdot x , y \qquad ( 4 )$$

$$Where , {dz}_{01} = low reception area coordinates , which is calculated based on found low reception area in {}^{′} {a}^{′} room .$$

$$dz\_a - low reception area in room {}^{′} {a}^{′} .$$

In an embodiment, the operation of identifying the boundary coordinates of one or more sub-areas around one or more weak strength devices by the extender requirement determination module 305-2, corresponds to the operation 503 of FIG. 5.

In an embodiment, the extender requirement determination module 305-2, at operation 413 of FIG. 4, determines the device requirements. In particular, the extender requirement determination module 305-2 determines one or more extender parameters for determining the determines the device requirements. As an example, the one or more extender parameters include a number of devices located in each of the one or more areas, the position of each of the one or more devices in each of the one or more areas, a number of devices covered by network coverage of each of the one or more strong strength devices, network requirements of each of the one or more weak strength devices, and an operating state of each of the one or more strong strength devices.

For example, the coverage can be estimated based on the number of devices located in each of the one or more areas. In an embodiment, estimating access point count depends on count of available devices (GSRD and PSRD). In an embodiment, a list of devices provided per room along with their positioning determines a minimum number of extenders required. In an embodiment, the extender requirement determination module 305-2 determines overall Wi-Fi requirements of available devices, like convergence Apps depending on Wi-Fi connection. In an embodiment, the convergence Apps are determined based on BLE discovery, to share device's capabilities in BLE packets. The BLE discovery packet from the device have designated bits to define Wi-Fi dependent apps (e.g. mirroring, casting, browsing). In an embodiment, if the PSRD is highly dependent on the Wi-Fi connection as its maximum apps are streaming based apps, then the system 300 prioritizes proximity of an extender to this PSRD or designate a dedicated extender.

Referring back to the FIG. 4, in an embodiment, the extender selection module 305-3, at operation 415 identify devices with extender capabilities. In particular, the extender selection module 305-3 detects one or more strong strength devices located in the proximity of the identified boundary coordinates of the one or more sub-areas based on the one or more device parameters, the one or more area parameters, and the Wi-Fi signal strength of each of the one or more devices. The detected one or more strong strength devices are the devices associated with the one or more devices having the Wi-Fi signal strength more than the predefined threshold signal strength.

In an embodiment, at operation 417, extender selection module 305-3 selects a best Wi-Fi extender candidate. In an embodiment, the extender selection module 305-3, at operation 417, identifies one or more required strong strength devices from the detected one or more strong strength devices based on the one or more extender parameters. In an embodiment, the identified one or more required strong strength devices is ensuring best possible maximum area with good signal and minimal compromises in device functionalities. For example, the identified one or more required strong strength devices is covering maximum number of the one or more sub-areas.

In an embodiment, the extender selection module 305-3 identify and lists the extender capable (i.e. GSRD) devices, near identified low reception area using their boundary coordinates and GSRD positioning. In an embodiment, capabilities of GSRDs which are located within range of ±dz. bound, are examined to determine whether the devices have extender capability, based on whether a Wi-Fi extender capability are added in a device IoT profile. Accordingly, based on the related functions the state of a device component or control a function of the device are retrieved. In a non-limiting example, the state of the device or controlling the function of the device indicates whether the device is ON or OFF, or whether it is extender capable or not. Using this attribute, the extender selection module 305-3 lists the devices with the extender profiles. These extender capable devices are candidates for next step where the best candidates are shortlisted (i.e., the one or more strong-strength devices).

In an embodiment, if the position of each of the one or more devices in each of the one or more areas is located in home center, then it will provide good signal quality to low reception area in surrounding if any. For example, refrigerator is generally located in center of home, and hence should be good candidate to provide maximum coverage, Accordingly, the refrigerator can be shortlisted in the one or more strong-strength devices.

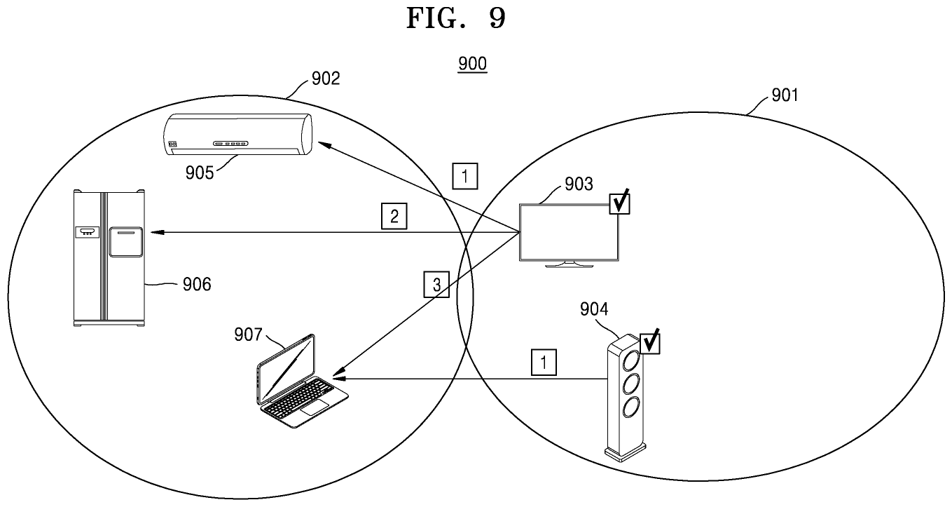

In an embodiment, the extender requirement determination module 305-2 shortlists devices in the one or more strong-strength devices which is covering maximum number of devices rather than the other covering only few. For example, FIG. 9 illustrates an example scenario of shortlisting the one or more strong-strength devices, according to an embodiment of the present disclosure. In an embodiment, the user environment 900 includes good signal quality area 901 and poor signal quality area 902. For example, the poor signal quality area 902 is low reception area. In an embodiment, the good signal quality area 901 includes TV 903, floor AC 904 and the poor signal quality area 902 includes room AC 905, refrigerator 906 and laptop 907. In an embodiment, shortlisted the one or more strong-strength devices include TV 903 and floor AC 904. In an embodiment, the TV 903 is able to cover three Wi-Fi dependent PRSD (room AC 905, refrigerator 906, laptop 907), while the Floor AC 904 is able to cover only one device (laptop 907). In an embodiment, the TV 903 is selected as the best candidate i.e., shortlisted in the one or more strong-strength devices (TV 903, floor AC 904). In an embodiment, the extender requirement determination module 305-2 consider “Power ON/OFF” status for deciding its extender role. For example, the refrigerator will always be in “On” state, rather than the floor AC, which will not be “ON” state always. But in worst case scenarios, if there is no other option then the floor AC, which is in “ON” state right currently will be selected as the best candidate.

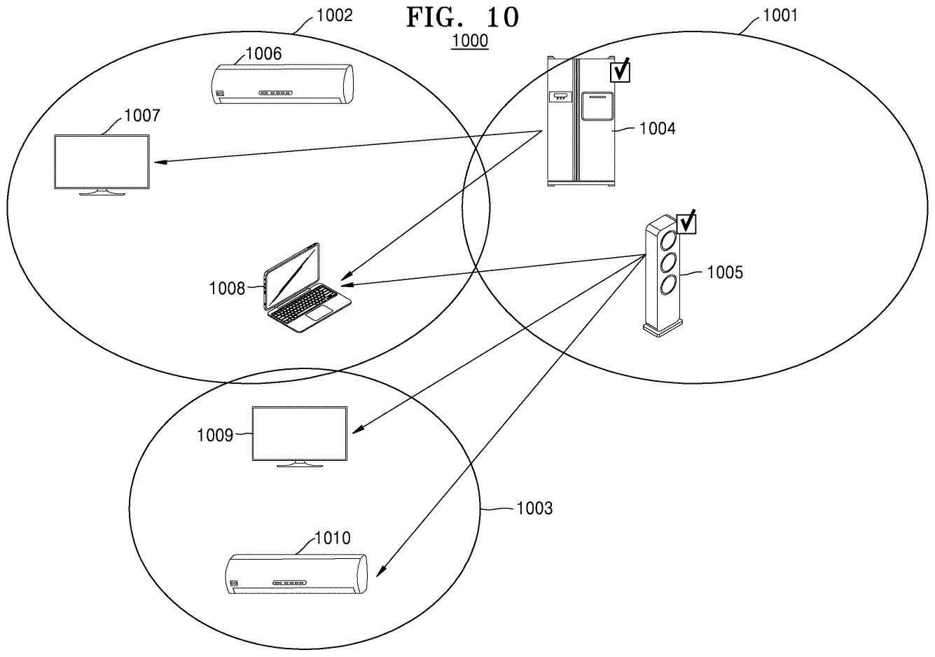

In an embodiment, the identified set of strong-strength devices ensures best possible maximum area with good signal and minimal compromises in a device functionality. According to some embodiments, the extender requirement determination module 305-2 performs device multiplexing when more than one extender is available near to low reception area and there is need of multiple extender based on device (PRSD) requirements. The use of multiple devices ensure maximum signal coverage. In an embodiment, the extender requirement determination module 305-2 detects that a set of strong-strength devices are located in proximity of a sub-area belonging to the one or more sub-areas. In an embodiment, the extender requirement determination module 305-2 determines, based on the one or more extender parameters, that the set of strong-strength devices are required for providing Wi-Fi signals to weak-strength devices located in the sub-area. In an embodiment, the set of strong-strength devices are used for device multiplexing. FIG. 10 illustrates an example scenario for device multiplexing, according to an embodiment of the present disclosure. In an embodiment, the user environment 1000 includes good signal quality area 1001, first poor signal quality area 1002 and second poor signal quality area 1003. For example, the first poor signal quality area 1002 and the second poor signal quality area 1003 each are separate low reception areas. In an embodiment, the good signal quality area 1001 includes refrigerator 1004 and floor AC 1005. In an embodiment, the first poor signal quality area 1002 includes room AC 1006, TV 1007 and laptop 1008. In an embodiment, the second poor signal quality area 1004 includes TV 1009 and room AC 1010. In an embodiment, shortlisted the one or more strong-strength devices include refrigerator 1004 and floor AC 1005. In an embodiment, the refrigerator 1004 cannot cover all devices in the first and second poor signal quality area 1002, 1003 but along with the floor AC 1005 (another candidate nearby to second poor signal quality area 1003) is able to cover overall devices in the first and second poor signal quality area 1002, 1003. In an embodiment, both the refrigerator 1004 and the floor AC 1005 can be used as Wi-Fi extender for device multiplexing.

In an embodiment, the detection of the one or more strong strength devices and identification of the one or more required strong strength devices from the detected one or more strong strength by the extender requirement determination module 305-2 at operation 415 and operation 417 corresponds to the operations 505 and 507 of FIG. 5 respectively. In an embodiment, upon determining that the one or more strong-strength devices are required for providing the Wi-Fi signal to weak-strength devices, the extender selection module 305-3 generates a device command to enable each of the set of strong-strength devices or the one or more strong-strength devices as the one or more Wi-Fi extenders for the weak-strength devices located in the sub-area. As an example, the device command corresponds to a specific instruction to enable each of the identified one or more required strong strength devices as the one or more Wi-Fi extenders.

Referring back to FIG. 4, In an embodiment, the enabling extender module 305-4 enables each of the identified one or more required strong-strength devices as the one or more Wi-Fi extenders for the one or more weak-strength devices located in the user environment. Based on the device command, the enabling extender module 305-4, at operation 419, converts the set of strong-strength devices or the one or more strong-strength devices as the one or more Wi-Fi extender.

Consider an example scenario, where the user is sitting in a balcony while working in a laptop. However, the laptop is receiving a bad signal. In an embodiment, adjacent bedroom has TV which is ON and identified as the best candidate for the extender role. According to disclosed methodology, the TV is enabled as the extender to provide better Wi-Fi signal to the laptop. Accordingly, the laptop is receiving a good signal.

According to the disclosed methodology, the disclosed method provides a unique method to identify and enable an optimal device into “Wi-Fi extender” role. This provides a maximum network coverage to enhance user experience in a user environment by demarcating boundaries of low reception areas within rooms having poor signals in an optimized manner by considering factors like room shape, its coordinates, devices positioning and device signal requirements to determine room's minimum signal requirements. In an embodiment, the devices around the boundaries with extender capabilities can be considered as the Object of Interest (Ool) for the WI-Fi extender role.

The plurality of modules 205 may be implemented by any suitable hardware and/or set of instructions. In an embodiment, the sequential flow illustrated in FIG. 2 is exemplary in nature and the embodiments may include the addition/omission of operations as per the requirement. In some embodiments, the one or more operations performed by the plurality of modules 205 may be performed by the processor/controller based on the requirement. While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to an embodiment.

In an embodiment, the method comprises identifying the one or more required strong strength device covering maximum number of the one or more sub-areas.

In an embodiment, the method comprises determining the one or more area parameters associated with each of one or more areas in the user environment by using a blueprint of the user environment.

In an embodiment, the one or more area parameters comprise at least one of a number of the one or more areas in the user environment, area coordinates, shape, wall coordinates, wall shape, wall width, wall thickness of each of the one or more areas, or information associated with the one or more devices present in each of the one or more areas.

In an embodiment, prior to determining one or more area parameters, the method comprises receiving live data associated with the user environment from one or more image-capturing devices. In an embodiment, the method comprises generating the blueprint associated with the user environment based on the received live data, wherein the blueprint comprises details related to a floor map, positions of the one or more devices, a shape of the user environment, and wall coordinates.

In an embodiment, the method comprises identifying the one or more device parameters associated with each of the one or more devices located in each of the one or more areas based on the determined one or more area parameters and the blueprint of the user environment.

In an embodiment, the one or more device parameters comprise at least one of an identifier, location coordinates, or a type of the one or more devices.

In an embodiment, the one or more extender parameters comprise a number of devices located in each of the one or more areas, position of each of the one or more devices in each of the one or more areas, a number of devices covered by network coverage of each of the one or more strong strength devices, network requirements of each of the one or more weak strength devices, and an operating state of each of the one or more strong strength devices.

In an embodiment, the method comprises transmitting a request to each of the one or more devices for obtaining the one or more device capabilities associated with each of the one or more devices. In an embodiment, the method comprises obtaining the one or more device capabilities from each of the one or more devices based on the transmitted request. In an embodiment, the method comprises transmitting, upon obtaining the one or more device capabilities, a request to each of the one or more devices for obtaining the Wi-Fi signal strength associated with each of the one or more devices;
obtaining the Wi-Fi signal strength from each of the one or more devices based on the transmitted request. In an embodiment, the method comprises determining the signal quality of each of the one or more areas based on the one or more device parameters, the obtained one or more device capabilities, and the obtained Wi-Fi signal strength of each of the one or more devices.

In an embodiment, the method comprises classifying, based on the determined signal quality of each of the one or more areas, each of the one or more areas into one of a poor-quality signal area and a good quality signal area. In an embodiment, the method comprises identifying, based on the determined signal quality, the one or more device parameters, one or more coordinate factors, and the one or more area parameters, boundary coordinates of the one or more sub-areas located inside the poor-quality signal area.

In an embodiment, the one or more coordinate factors comprise at least one of a location of each of the one or more weak strength devices, a shape of each of the one or more areas, and wall coordinates.

In an embodiment, the method comprises detecting that a set of strong-strength devices are located in proximity of a sub-area belonging to the one or more sub-areas. In an embodiment, the method comprises determining, based on one or more extender parameters, that the set of strong-strength devices are required for providing Wi-Fi signals to weak-strength devices located in the sub-area. In an embodiment, the method comprises generating, upon determining that the set of strong-strength devices are required for providing the Wi-Fi signal to weak-strength devices, a device command to enable each of the set of strong-strength devices as the one or more Wi-Fi extenders for the weak-strength devices located in the sub-area, wherein the device command corresponds to a specific instruction to enable each of the identified one or more required strong strength devices as the one or more Wi-Fi extenders.

In an embodiment, A system for enabling one or more Wireless-Fidelity (Wi-Fi) extenders in a user environment is provided. In an embodiment the system comprises a memory; and one or more processors communicatively coupled to the memory, wherein the memory comprises a plurality of modules in the form of programmable instructions executable by the one or more processors. In an embodiment, the plurality of modules comprises at least one of a signal quality determination module, an extender requirement determination module, an extender selection module, an enabling module, a map plugin module or a blueprint generation module. In an embodiment, the signal quality determination module determines signal quality of each of one or more areas in the user environment based on one or more device parameters, one or more device capabilities, and a Wi-Fi signal strength of each of one or more devices. In an embodiment, the extender requirement determination module identifies, based on the determined signal quality, the one or more device parameters, and one or more area parameters, boundary coordinates of one or more sub-areas around one or more weak strength devices, wherein the one or more weak strength devices are devices from among the one or more devices having a Wi-Fi signal strength less than a predefined threshold signal strength. In an embodiment the extender selection module detects, based on the one or more device parameters, the one or more area parameters, and the Wi-Fi signal strength of each of the one or more devices, one or more strong strength devices located in the proximity of the identified boundary coordinates of the one or more sub-areas, wherein the detected one or more strong strength devices are devices associated with the one or more devices having a Wi-Fi signal strength more than the predefined threshold signal strength. In an embodiment, the extender selection module identifies one or more required strong strength devices from the detected one or more strong strength devices based on one or more extender parameters. In an embodiment, the enabling module enables each of the identified one or more required strong-strength devices as the one or more Wi-Fi extenders for the one or more weak-strength devices located in the user environment.

In an embodiment, the map plugin module determines the one or more area parameters associated with each of one or more areas in the user environment by using the blueprint of the user environment.

In an embodiment, the one or more area parameters comprise at least one of a number of the one or more areas in the user environment, area coordinates, shape, wall coordinates, wall shape, wall width, wall thickness of each of the one or more areas, or information associated with the one or more devices present in each of the one or more areas.

In an embodiment, the blueprint generation module receives live data associated with the user environment from one or more image-capturing devices. In an embodiment, the blueprint generation module generates the blueprint associated with the user environment based on the received live data, wherein the blueprint comprises details related to a floor map, positions of the one or more devices, a shape of the user environment, and wall coordinates.

In an embodiment, the map plugin module identifies the one or more device parameters associated with each of the one or more devices located in each of the one or more areas based on the determined one or more area parameters and the blueprint of the user environment.

In an embodiment, the one or more device parameters comprise at least one of an identifier, location coordinates, or a type of the one or more devices.

In an embodiment, the one or more extender parameters comprise a number of devices located in each of the one or more areas, position of each of the one or more devices in each of the one or more areas, a number of devices covered by network coverage of each of the one or more strong strength devices, network requirements of each of the one or more weak strength devices, and an operating state of each of the one or more strong strength devices.

In an embodiment, the signal quality determination module transmits a request to each of the one or more devices for obtaining the one or more device capabilities associated with each of the one or more devices. In an embodiment, the signal quality determination module obtains the one or more device capabilities from each of the one or more devices based on the transmitted request. In an embodiment, the signal quality determination module transmits, upon obtaining the one or more device capabilities, a request to each of the one or more devices for obtaining the Wi-Fi signal strength associated with each of the one or more devices. In an embodiment, the signal quality determination module obtains the Wi-Fi signal strength from each of the one or more devices based on the transmitted request. In an embodiment, the signal quality determination module determines the signal quality of each of the one or more areas based on the one or more device parameters, the obtained one or more device capabilities, and the obtained Wi-Fi signal strength of each of the one or more devices.

In an embodiment, the extender requirement determination module classifies, based on the determined signal quality of each of the one or more areas, each of the one or more areas into one of a poor-quality signal area and a good quality signal area. In an embodiment, the extender requirement determination module identifies, based on the determined signal quality, the one or more device parameters, one or more coordinate factors, and the one or more area parameters, boundary coordinates of the one or more sub-areas located inside the poor-quality signal area.

In an embodiment, the one or more coordinate factors comprise at least one of a location of each of the one or more weak strength devices, a shape of each of the one or more areas, and wall coordinates.

In an embodiment, the extender selection module detects that a set of strong-strength devices are located in proximity of a sub-area belonging to the one or more sub-areas. In an embodiment, the extender selection module determines, based on one or more extender parameters, that the set of strong-strength devices are required for providing Wi-Fi signals to weak-strength devices located in the sub-area. In an embodiment, the extender selection module generates, upon determining that the set of strong-strength devices are required for providing the Wi-Fi signal to weak-strength devices, a device command to enable each of the set of strong-strength devices as the one or more Wi-Fi extenders for the weak-strength devices located in the sub-area, wherein the device command corresponds to a specific instruction to enable each of the identified one or more required strong strength devices as the one or more Wi-Fi extenders. In an embodiment, the system 200 determines the one or more area parameters associated with each of one or more areas in the user environment by using the blueprint of the user environment.

In an embodiment, the one or more area parameters comprise at least one of a number of the one or more areas in the user environment, area coordinates, shape, wall coordinates, wall shape, wall width, wall thickness of each of the one or more areas, or information associated with the one or more devices present in each of the one or more areas.

In an embodiment, the system 200 receives live data associated with the user environment from one or more image-capturing devices. In an embodiment, the system 200 generates the blueprint associated with the user environment based on the received live data, wherein the blueprint comprises details related to a floor map, positions of the one or more devices, a shape of the user environment, and wall coordinates.

In an embodiment, the system 200 identifies the one or more device parameters associated with each of the one or more devices located in each of the one or more areas based on the determined one or more area parameters and the blueprint of the user environment.

In an embodiment, the one or more device parameters comprise at least one of an identifier, location coordinates, or a type of the one or more devices.

In an embodiment, the one or more extender parameters comprise a number of devices located in each of the one or more areas, position of each of the one or more devices in each of the one or more areas, a number of devices covered by network coverage of each of the one or more strong strength devices, network requirements of each of the one or more weak strength devices, and an operating state of each of the one or more strong strength devices.

In an embodiment, the system 200 transmits a request to each of the one or more devices for obtaining the one or more device capabilities associated with each of the one or more devices. In an embodiment, the system 200 obtains the one or more device capabilities from each of the one or more devices based on the transmitted request. In an embodiment, the system 200 transmits, upon obtaining the one or more device capabilities, a request to each of the one or more devices for obtaining the Wi-Fi signal strength associated with each of the one or more devices. In an embodiment, the system 200 obtains the Wi-Fi signal strength from each of the one or more devices based on the transmitted request. In an embodiment, the system 200 determines the signal quality of each of the one or more areas based on the one or more device parameters, the obtained one or more device capabilities, and the obtained Wi-Fi signal strength of each of the one or more devices.

In an embodiment, the system 200 classifies, based on the determined signal quality of each of the one or more areas, each of the one or more areas into one of a poor-quality signal area and a good quality signal area. In an embodiment, the system 200 identifies, based on the determined signal quality, the one or more device parameters, one or more coordinate factors, and the one or more area parameters, boundary coordinates of the one or more sub-areas located inside the poor-quality signal area.

In an embodiment, the one or more coordinate factors comprise at least one of a location of each of the one or more weak strength devices, a shape of each of the one or more areas, and wall coordinates.

In an embodiment, the system 200 detects that a set of strong-strength devices are located in proximity of a sub-area belonging to the one or more sub-areas. In an embodiment, the system 200 determines, based on one or more extender parameters, that the set of strong-strength devices are required for providing Wi-Fi signals to weak-strength devices located in the sub-area. In an embodiment, the system 200 generates, upon determining that the set of strong-strength devices are required for providing the Wi-Fi signal to weak-strength devices, a device command to enable each of the set of strong-strength devices as the one or more Wi-Fi extenders for the weak-strength devices located in the sub-area, wherein the device command corresponds to a specific instruction to enable each of the identified one or more required strong strength devices as the one or more Wi-Fi extenders.

1. A method for enabling one or more Wireless-Fidelity (Wi-Fi) extenders in a user environment, the method comprising:
determining a signal quality of one or more areas in the user environment based on at least one of one or more device parameters, one or more device capabilities, or a Wi-Fi signal strength of one or more devices, respectively;
identifying, based on the determined signal quality, the one or more device parameters, and one or more area parameters, boundary coordinates of one or more sub-areas around one or more weak strength devices, among the one or more devices, having a first Wi-Fi signal strength that is less than a predefined threshold signal strength;
detecting, based on the one or more device parameters, the one or more area parameters, and the Wi-Fi signal strength of the one or more devices, respectively, one or more strong strength devices located in proximity of the identified boundary coordinates of the one or more sub-areas, the detected one or more strong strength devices having a second Wi-Fi signal strength that is more than the predefined threshold signal strength;
identifying one or more candidate strong strength devices from the detected one or more strong strength devices based on one or more extender parameters; and
enabling the identified one or more candidate strong strength devices, respectively, to operate as the one or more Wi-Fi extenders.

2. The method of claim 1, wherein the identifying of the one or more candidate strong strength devices comprises:
identifying the one or more candidate strong strength devices covering a maximum number of the one or more sub-areas.

3. The method of claim 1, further comprising:
determining the one or more area parameters associated with the one or more areas in the user environment by using a blueprint of the user environment.

4. The method of claim 3, wherein the one or more area parameters comprise at least one of a number of the one or more areas in the user environment, area coordinates, a shape, wall coordinates, a wall shape, a wall width, a wall thickness of the one or more areas of the one or more areas, or information associated with the one or more devices present in the one or more areas, respectively.

5. The method of claim 3, wherein prior to determining one or more area parameters, the method comprises:
receiving live data associated with the user environment from one or more image capturing devices; and
generating the blueprint associated with the user environment based on the received live data, the blueprint comprising details related to a floor map, positions of the one or more devices, a shape of the user environment, and wall coordinates of the one or more areas.

6. The method of claim 3, further comprising:
identifying the one or more device parameters associated with the one or more devices located in the one or more areas, respectively, based on the determined one or more area parameters and the blueprint of the user environment.

7. The method of claim 1, wherein the one or more device parameters comprise at least one of an identifier, location coordinates, or a type of the one or more devices.

8. The method of claim 1, wherein the one or more extender parameters respectively comprises:
a number of devices located in the one or more areas, a position of the one or more devices in the one or more areas, a number of devices covered by network coverage of the one or more strong strength devices, network requirements of the one or more weak strength devices, and an operating state of the one or more strong strength devices.

9. The method of claim 1, wherein determining the signal quality of the one or more areas, respectively, comprises:
transmitting a request to the one or more devices to obtain the one or more device capabilities associated with the one or more devices, respectively;
obtaining the one or more device capabilities from the one or more devices based on the transmitted request;
transmitting, upon obtaining the one or more device capabilities, a request to the one or more devices to obtain the Wi-Fi signal strength associated with the one or more devices;
obtaining the Wi-Fi signal strength from the one or more devices based on the transmitted request; and
determining the signal quality of the one or more areas, respectively, based on the one or more device parameters, the obtained one or more device capabilities, and the obtained Wi-Fi signal strength of the one or more devices.

10. The method of claim 1, wherein identifying the boundary coordinates of the one or more sub-areas comprises:
classifying, based on the determined signal quality of the one or more areas, the one or more areas into one of a poor-quality signal area and a good quality signal area; and
identifying, based on the determined signal quality, the one or more device parameters, one or more coordinate factors, and the one or more area parameters, boundary coordinates of the one or more sub-areas located inside the poor-quality signal area.

11. The method of claim 10, wherein the one or more coordinate factors comprise at least one of a location of the one or more weak strength devices, a shape of the one or more areas, and wall coordinates.

12. The method of claim 1, further comprising:
detecting that a set of strong strength devices are located in proximity of a sub-area belonging to the one or more sub-areas;
determining, based on the one or more extender parameters, that the set of strong strength devices are required to provide Wi-Fi signals to weak strength devices located in the sub-area; and
generating, upon determining that the set of strong strength devices are required to provide the Wi-Fi signal to the weak strength devices, a device command to enable the set of strong strength devices to operate as the one or more Wi-Fi extenders for the weak strength devices located in the sub-area,
wherein the device command corresponds to a specific instruction to enable the identified one or more candidate strong strength devices to operate as the one or more Wi-Fi extenders.

13. A system for enabling one or more Wireless-Fidelity (Wi-Fi) extenders in a user environment, the system comprising:
a memory to store one or more computer programs; and
one or more processors, (201) communicatively coupled to the memory, to execute the one or more computer programs or at least one instruction stored in the memory to cause the system to:
determine a signal quality of one or more areas in the user environment based on at least one of one or more device parameters, one or more device capabilities, or a Wi-Fi signal strength of one or more devices, respectively;
identify, based on the determined signal quality, the one or more device parameters, and one or more area parameters, boundary coordinates of one or more sub-areas around one or more weak strength devices, among the one or more devices, having a first Wi-Fi signal strength less than a predefined threshold signal strength;
detect, based on the one or more device parameters, the one or more area parameters, and the Wi-Fi signal strength of the one or more devices, respectively, one or more strong strength devices located in proximity of the identified boundary coordinates of the one or more sub-areas, the detected one or more strong strength devices having a second Wi-Fi signal strength that is more than the predefined threshold signal strength; and
identify one or more candidate strong strength devices from the detected one or more strong strength devices based on one or more extender parameters; and
enable the identified one or more candidate strong strength devices, respectively, to operate as the one or more Wi-Fi extenders for the one or more weak strength devices located in the user environment.

14. The system of claim 13, wherein the one or more processors execute the one or more computer programs or at least one instruction stored in the memory to cause the system to:
determine the one or more area parameters associated with one or more areas in the user environment by using a blueprint of the user environment.

15. A non-transitory computer readable medium storing therein instructions executable to cause at least one processor of a system to implement the method of claim 1.
